(19) United States
(12) Patent Application Publication
(10) Pub. No.: US 2026/0218558 A1
(43) Pub. Date: Jul. 30, 2026

(54) Sliding Door Gear

(71) Applicant: SAMET KALIP VE MADENI ESYA SANAYI VE TICARET A.S., Istanbul (TR)

(72) Inventors: Artur Hirtsiefer, Neunkirchen-Seelscheid (DE); Himmet Tanriverdi, Istanbul (TR); Evren Urak, Istanbul (TR)

(21) Appl. No.: 19/157,916

(22) PCT Filed: May 4, 2023
(86) PCT No.: PCT/TR2023/050411

§ 371 Date: Aug. 19, 2025

(51) Int. Cl. E05F 1/16

(52) U.S. Cl. CPC E05F 1/16; E05Y 2201/484; E05Y 2201/499; E05Y 2201/618; E05Y 2201/652; E05Y 2201/656; E05Y 2201/726; E05Y 2900/132; E05Y 2900/20

(57) ABSTRACT

A sliding door gear includes at least one door attachment unit for mounting at least one sliding door to a stationary structure, such as a door frame or a piece of furniture, wherein the door attachment unit can be moved between a closed position and an open position along a main opening direction Increased user comfort when opening and/or closing at least one sliding door is achieved in that an opening and/or closing mechanism is provided, in that the opening and/or closing mechanism comprises a flexible tension member and a retracting device adapted to retract the flexible tension member, and in that by retraction of the flexible tension member the door attachment unit is urged in and/or against the main opening direction.

The invention relates to a sliding door gear comprising at least one door attachment unit for mounting at least one sliding door to a stationary structure, such as a door frame or a piece of furniture, in particular a cabinet, wherein the door attachment unit can be moved between a closed position and an open position along a main opening direction.

A sliding door gear is known from WO 2021/173088 A1 . The sliding door gear comprises two moving parts attached to respective sliding doors. The moving parts are slidable on two linear guides in order to allow for slidable movement of the sliding doors between their closed and open states.

The technical problem solved by the invention is to provide a sliding door gear that offers increased user comfort when opening and/or closing at least one sliding door.

The problem is solved in that an opening and/or closing mechanism is provided, in that the opening and/or closing mechanism comprises a flexible tension member and a retracting device adapted to retract the flexible tension member, and in that by retraction of the flexible tension member the door attachment unit is urged in and/or against the main opening direction. In particular, the flexible tension member transmits a force to the door attachment unit to urge the door attachment unit in and/or against the main opening direction. Preferably, the main opening direction may be parallel to a front face of the sliding door.

By provision of the urging force by the opening and/or closing mechanism, the user may at least be supported in opening and/or closing the sliding door. Preferably, the opening and/or closing may provide for an automatic opening and/or closing of the door.

Force transmission by a flexible tension member provides the advantage that the opening and/or closing mechanism may be easily adapted to cabinets equipped with different sizes of sliding doors and/or distances to be overcome by the sliding doors to be moved between an open and a closed state. Further, an opening and/or closing mechanism comprising a flexible tension member may be easily installed, because a flexible tension member can easily compensate for positional tolerances of attachment points relative to each other.

According to a preferred embodiment of the invention, the flexible tension member may comprise a wire, cable, rope and/or a tape. In particular, the flexible tension member may consist of a wire, cable, rope, and/or a tape.

Reliable retraction of the flexible tension member may be achieved by simple means if it is provided that the retracting device comprises a spool rotatable about a first rotational axis, and that, during retraction, the flexible tension member is being wound up on the spool.

The flexible tension member may transmit the force urging the door attachment unit in and/or against the main opening direction between the retracting device and an attachment point of the flexible tension member to another part of the sliding door gear. The flexible tension member may, in a longitudinal first end region, be coupled to the attachment point, and may, in a longitudinal second end region opposite the first end region, be coupled to the retracting device.

In this context, according to a preferred variant of the invention, it is proposed that the flexible tension member is held at an attachment point spaced apart from the retracting device, wherein the attachment point is provided on the door attachment unit and the retracting device is adapted to be fixed to the stationary structure, or vice versa. In this way, the urging force may thus act between the stationary structure and the door attachment unit, which may provide for opening and/or closing of a single sliding door. Alternatively, if more than one sliding door is provided, the attachment point and the retracting device may be respectively provided on a respective door attachment unit associated with the respective door. In other words, the opening and/or closing mechanism may act between two door attachment units. This may yield the advantage that a single opening and/or closing mechanism may provide for opening and/or closing of more than one sliding door.

A preferred variant of the invention may be characterized in that the opening and/or closing mechanism comprises an energy storage, wherein a release of energy stored in the energy storage is associated with a retraction of the flexible tension member. Consequently, the energy released from the energy storage may be translated into an urging force on the door attachment unit in and/or against the main opening direction. During movement of the door attachment unit in the opposite direction, the flexible tension member may thus be extended, which may be associated with a charging of the energy storage.

Energy may be stored in an effective and simple way if the energy storage comprises a spring. In particular, the spring may be a torsion spring, preferably a helical torsion spring. The energy stored in the energy storage may at least partially stored in the form of an elastic deformation of the spring. Accordingly, the energy charging and/or release characteristics, and thereby at least to some degree the characteristics of the urging force provided by the opening and/or closing mechanism, may be adapted by an appropriate choice of the spring to be used. Springs are commercially available in various types, sizes and/or with various spring constants. Hence, an energy storage comprising a spring may also provide for easy adaptability of the energy storage to the specific requirements of the opening and/or closing mechanism and/or the sliding door gear to be equipped with an opening and/or closing mechanism.

In a preferred embodiment, the tension of the spring can be adjusted. In this context, in particular if the spring is a torsion spring, the adjustment may be achieved by means of a defined twisting of a second end region against a first end region of the spring, preferably about a longitudinal central axis of the spring. Adjustment of the tension of the spring may provide for adaptability to specific needs of the application, for instance, heavier doors to be moved may necessitate a higher tension of the spring.

According to a variant of the invention, it is proposed that the opening and/or closing mechanism comprises a transmission mechanism, and in that the transmission mechanism couples the retracting device and the energy storage, preferably enabling a transformation of forces and/or movements therebetween. For example, the transmission mechanism may provide for adapting a desired length of retraction of the flexible tension member and a desired amount of deformation of the spring. The retraction of the flexible tension member may correspond to the flexible tension member being wound up, thus being related to a rotational movement. In the case of a torsion spring, a movement of the energy storage to be translated to the retracting device may also be a rotational movement. In this case, for translation between two rotational movements, it is conceivable to provide for the transmission mechanism to comprise a gear mechanism, for instance. If the spring, on the other hand, is a compression spring, the transmission mechanism may be adapted to convert between the rotational movement associated with the retracting device and a linear movement associated with the energy storage. In this case, the transmission mechanism may comprise a lever mechanism, a linkage mechanism or a rack-and-pinion mechanism.

Further, the magnitude of forces and/or torques may be transformed by the transmission mechanism between the retracting device and the energy storage.

In a preferred embodiment, it may be provided that the transmission mechanism comprises at least a first and a second transmission element, which are in operative engagement with another. The transmission elements may preferably be gears, pulleys or sprockets. Operative engagement may, in the case of gears, mean meshing of the transmission elements. In the case of pulleys, it may relate to the transmission elements being looped over by a common belt, or in the case of sprockets, by a common chain. To ensure accurate rotational relationships between transmission elements, at least largely non-slipping transmission may be preferable, such as in the case of gears, chains or toothed belts.

In the context of transmission of movement and/or forces associated with the retraction of the flexible tension member, it may preferably be provided that the first transmission element is coupled to the/a spool of the retracting device in a rotationally fixed manner such that it is rotatable about the first rotational axis together with the spool.

In the context of transmission of forces and/or movements associated with the energy storage, it may be provided that the second transmission element is coupled to the energy storage. The second transmission element may be rotatable about a second rotational axis. Preferably, a rotation of the second transmission element, depending on the sense of rotation, may increase or decrease the amount of energy stored in the energy storage, respectively.

In particular if the energy storage comprises a torsion spring, elastic deformation of the spring may be coupled with a rotation of the second transmission element in a simple and effective manner, if it is provided that, at a longitudinal first end region, the spring is secured against a rotation about the second rotational axis, and that, at a longitudinal second end region opposite the first end region, the spring is coupled to the second transmission element in a rotationally fixed manner.

Preferably, the spring may comprise a coupling element in its second end region, which coupling element may be coupled to a counter coupling element provided on the second transmission element. Preferably, the spring may be arranged along the second rotational axis. The spring may be securely mounted and, in particular, secured against buckling, if it is provided that the spring is held on a rod. Preferably, the rod may be arranged along the second rotational axis.

For elastic deformation of the spring associated with a rotation of the second transmission element, it may in particular be provided that the first end region of the spring is rotationally fixed to the rod at a fixing section of the rod and that the rod and/or the fixing section, at least during operation of the opening and/or closing mechanism, is/are blocked against rotation about the second rotational axis. Operation of the opening and/or closing mechanism may refer to a movement of the door attachment unit between its closed and open state.

Preferably, to allow for an adjustment of the spring tension, the blocking against rotation about the second rotational axis may be releasable, such that an angular orientation of the rod and/or the fixing section about the second rotational axis is adjustable.

A compact and mechanically robust design may be achieved in that the opening and/or closing mechanism comprises a support body, which support body supports the retracting device, the transmission mechanism, and the energy storage. The support body may be coupled to the stationary structure or to the door attachment unit. Such coupling can be direct or indirect. For instance, the support body may be manufactured, in particular, integrally with a component of the door attachment unit, and/or be provided with attachment means for fixing the support body to one of the door attachment units or to the stationary structure.

According to a preferred variant of the invention, the door attachment unit may be guided along the main opening direction on at least one guide element, preferably linear guide element, in particular a rail. Further preferably, the main opening direction is parallel to a front face of the sliding door.

The invention will be further described by way of example with reference to the drawings, in which:

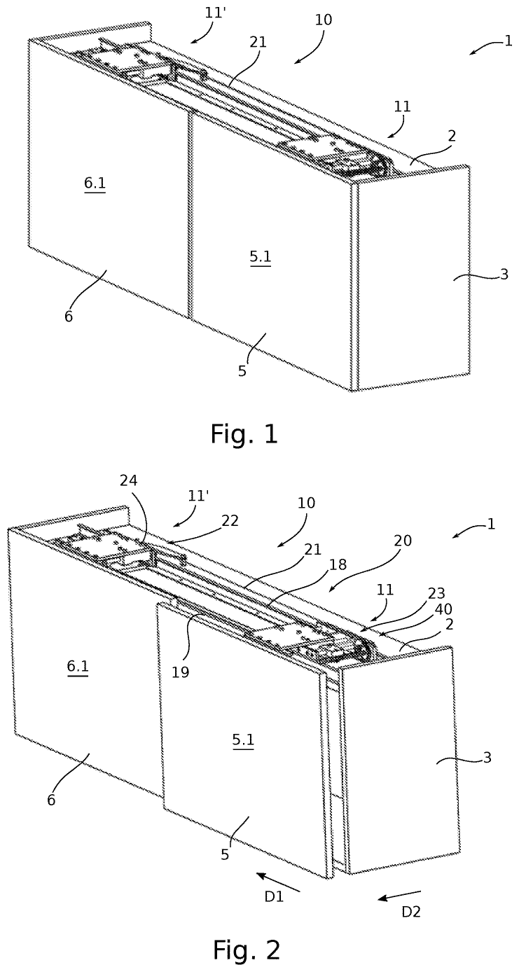

FIG. 1 is a perspective view of a cabinet with two sliding doors in a closed state and a sliding door gear,

FIG. 2 is a perspective view of the cabinet with one of the sliding doors in an intermediate state,

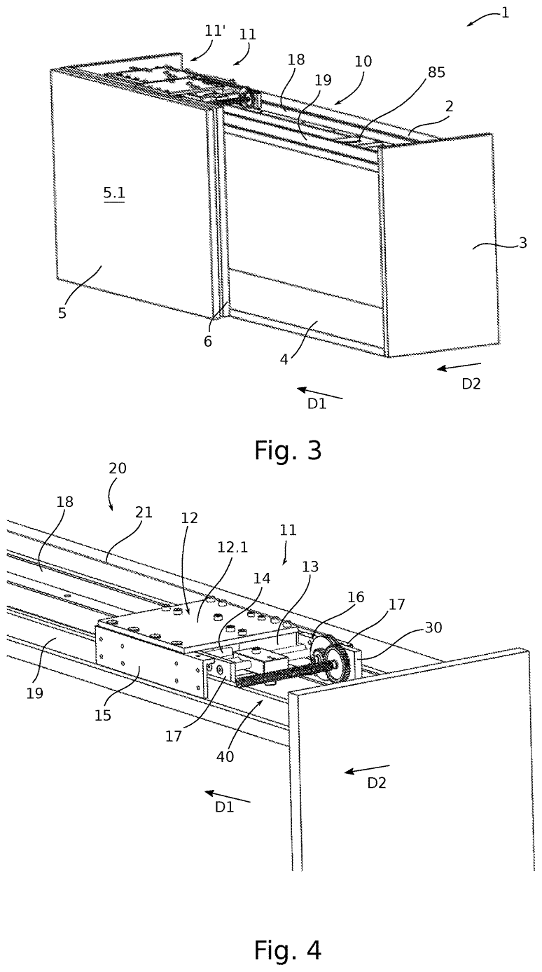

FIG. 3 is a perspective view of a cabinet with one of sliding doors in an open state,

FIG. 4 is a perspective view of a door attachment unit,

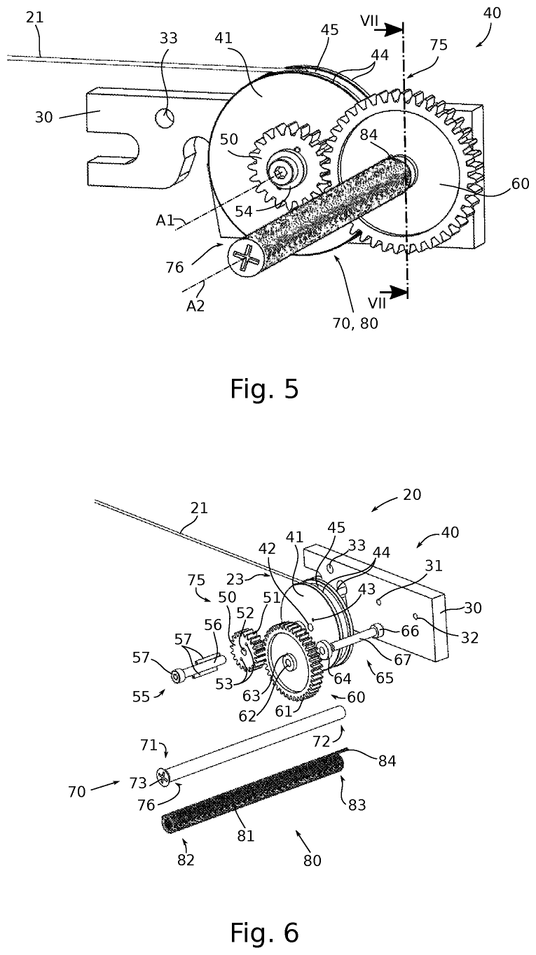

FIG. 5 is a perspective view of an opening and/or closing mechanism,

FIG. 6 is a perspective exploded view of an opening and/or closing mechanism,

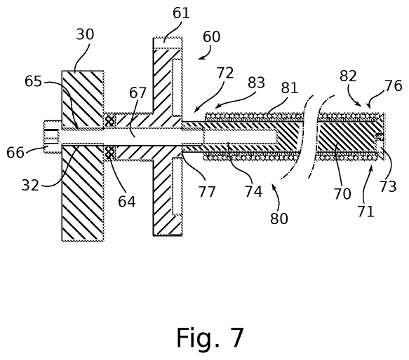

FIG. 7 is a sectional view at the location indicated with VII in FIG. 5.

FIG. 1 shows a perspective view of a cabinet 1 to which a sliding door gear 10 is mounted. The sliding door gear 10 comprises a door attachment unit 11 and a further door attachment unit 11′, to which a sliding door 5 and a further sliding door 6 are mounted, respectively. Thereby, the sliding doors 5, 6 are mounted to the cabinet 1.

The cabinet 1 may comprise a bottom wall 4 (cf. FIG. 3), a top wall 2, two side walls 3 and a rear wall. As shown in FIG. 1, the sliding door gear 10 may be mounted on the top wall 2 of the cabinet 1.

The door attachment unit 11, and preferably the further door attachment unit 11′, are movable between a closed position and an open position. FIG. 1 shows both sliding doors 5, 6 in a closed state. A closed state of a sliding door 5, 6 may correspond to the respective door attachment unit 11, 11′ being in a closed position.

In FIG. 2, the sliding door 5 is shown in an intermediate state. In this intermediate state, the sliding door 5 may be displaced relative to its closed state in a secondary opening direction D 2, which may be a direction facing away from the cabinet 1, in particular, as shown in FIG. 2, a direction normal to a front face 5.1 of the sliding door 5. While the sliding door 5 is in the intermediate state, the door attachment unit 11 may still be in the closed position. That is, a door attachment unit 11, 11′ may be in its closed position when a respective sliding door 5, 6 mounted thereto is in its closed and/or intermediate state.

The displacement of the sliding door 5 into the intermediate state may be enabled by the door attachment unit 11 the sliding door 5 is mounted to. As shown in FIG. 4, the door attachment unit 11 may comprise a retractable part 12 that may be movable relative to a non-rectractable part 16 of the door attachment unit 11 in and against the secondary opening direction D2.

The non-rectractable part 16 may comprise two frame members 17 that may be arranged in parallel to one another and spaced from one another in the secondary opening direction D2. The retractable part 12 may comprise a plate member 12.1 to which one or more guide members 13 may be fixed. The guide members 13 may comprise linear bearing means, such as linear roller bearings and/or linear plain bearings, that may be guided on a guide rod 14. One or more guide rods 14 may be provided on the non-rectractable part 16. The guide rod(s) 14 may preferably be aligned with the secondary opening direction D2.

As can further be gathered from FIG. 4, the retractable part 12 may comprise a door mount 15, to which the sliding door 5 may be fixed. For instance, the door mount 15 may comprise bores, through which screws may be guided in order to be fixed to the sliding door 5. The door mount 15 may be fixed to the plate member 12.1, for instance, by a bolted connection.

Movement of the retractable part 12 relative to the non-rectractable part 16 may be accomplished by provision of a guide curve 85, in which a guide element, such as, for example, a pin provided on the retractable part 12 may be guided. The guide curve 85 is best visible in FIG. 3.

From the intermediate state, the sliding door 5 may be movable along a main opening direction D1 into an open state, which state is shown in FIG. 3. In the open state, access to an interior of the cabinet 1 previously obstructed by the sliding door 5 may be provided. Preferably, and as shown in the Figures, the sliding door 5 may, in the open state, at least partially be located in front of the further sliding door 6, i.e., displaced relative to the further sliding door 6 in the secondary opening direction D2.

The sliding door 5 being in the open state may correspond to the door attachment unit 11 being in an open position. In other words, the door attachment unit 11 may be moved along the main opening direction D1 from its closed to its open position in order to displace the sliding door 5 from its intermediate to its open state.

Movability of the door attachment unit 11 along the main opening direction D1 may be provided by guide rails 18, 19 on which the door attachment unit 11 is guided. In the embodiment shown, the sliding door gear 10 comprises a first rail 18 and a second rail 19, on which both door attachment units 11, 11′ are guided. The rails 18, 19 may essentially extend parallel to the main opening direction D1 along the length necessary to provide for sufficient opening of the sliding doors 5, 6. In particular, the rails 18, 19 may extend over most of the distance between opposing side walls 3 of the cabinet 1.

Guidance of the door attachment units 11, 11′ on the guide rails 18, 19 may be provided by guide elements, such as, for instance, rollers provided on the door attachment units 11, 11′. Preferably, the guide elements may be provided on the non-rectractable part 16 of the door attachment units 11, 11′. For instance, guide elements to be guided on a respective rail 18, 19 may be provided on respective opposing frame members 17 of the non-rectractable part 16. As stated above, a guide curve 85 may be provided for movement of the retractable part 12 relative to the non-rectractable part 16 in the secondary opening direction D2. As seen in FIG. 3, the guide curve 85 may be provided between the first rail 18 and the second rail 19. Although FIG. 3 only shows a guide curve 85 to be operative with the door attachment unit 11, a guide curve 85 may also be provided for the further door attachment unit 11′. Preferably, guide curves 85 may be provided in a region along the main opening direction D1 where the door attachment unit 11, 11′ is located when in its closed position.

In general, it should be noted that structural features as well as function as described herein, where discussed by example for the sliding doors 5 and/or the door attachment unit 11, may, of course, also apply to the further sliding door 6 and/or door attachment unit 11′.

As has been explained, to open the sliding doors 5, 6, they may be first moved from a closed state to an intermediate state in the secondary opening direction D2. This movement may be performed by a user manually. It is also conceivable that a mechanism may be provided to support the user in performing this movement. For instance, a push-open mechanism may be provided which urges the door from the closed state toward the intermediate state upon a user input, such as an overhaul by pressing on the front face 5.1, 6.1 of the sliding door 5, 6. From the intermediate state, the sliding door 5, 6 may then be moved in the main opening direction D1 toward its open state.

An opening sequence as described above including a secondary opening direction D2 and a main opening direction D1 may provide for front faces 5.1, 6.1 of more than one sliding door 5, 6 to be coplanar in their closed state. However, it is also conceivable that at least one sliding door 5, 6 is movable only along the main opening direction D1, such that no movability in the secondary opening direction D2 is provided. In this case, the sliding door 5, 6 may be moved from its closed state toward its open state without passing an intermediate state.

To facilitate movement of the sliding doors 5, and preferably the further sliding door 6, in and/or against the main opening direction D1, the sliding door gear 10 comprises an opening and/or closing mechanism 20. The opening and/or closing mechanism 20 is adapted to urge the door attachment unit 11, 11′ associated with the sliding door 5, 6 to be opened or closed in or against the main opening direction D1.

Urging of the door attachment unit 11, 11′ by the opening and/or closing mechanism 20 may be inhibited if the door is in the closed state. Preferably, the guide curve 85 may provide for the inhibition of movement of the door attachment unit 11, 11′ in the main opening direction D1. In particular, the guide curve 85 may comprise a section that is arranged at an angle to the main opening direction D1 such that movement of the sliding door 5, 6 in and/or against the main opening direction D1 is prohibited unless the sliding door 5, 6 is moved to the intermediate state first. Of course, other means are conceivable, such as a threshold force a user needs to overcome to move the door attachment unit 11, 11′ slightly from its closed position before the opening and/or closing mechanism 20 may exhibit the urging force.

As best visible in FIGS. 1 and 2, the opening and/or closing mechanism 20 comprises a flexible tension member 21 and a retracting device 40. In the embodiment shown, the flexible tension member 21 is a wire.

The flexible tension member 21 may be, in a first end region 22, fixed to the further door attachment unit 11′ unit at an attachment point 24. In a second end region 23 longitudinally opposing the first end region 22, the flexible tension member 21 may be connected to a retracting device 40. The retracting device 40 is adapted to retract the flexible tension member 21.

As best visible in FIG. 4, the retracting device 40 may be fixed to the door attachment unit 11. For instance, a support body 30 of the retracting device 40 may be provided that may be fixed to the door attachment unit 11, in particular to the non-rectractable part 16.

FIG. 5 shows an embodiment of a retracting device 40 in more detail. As can be gathered from this drawing, the retracting device 40 may comprise a spool 41. The spool 41 may be rotatable about a first rotational axis A1. In particular, the spool 41 may be rotatably held at the support body 30. The spool 41 may be configured such that upon retraction of the flexible tension member 21, the spool 41 rotates about the first rotational axis A1, whereby the flexible tension member 21 is wound up on the spool 41 on its circumferential surface 45. Preferably, the spool 41 may comprise two opposed flanges 44, such that the circumferential surface 45 comprises a circumferential slot in which the flexible tension member 21 may be securely guided.

Rotatable about the same first rotational axis A1, but rotationally fixed to the spool 41, there may be provided a first transmission element 50 of a transmission mechanism 75 of the opening and/or closing mechanism 20. The transmission mechanism 75 may couple the retracting device 40 and an energy storage 80 in a way that enables a transformation of forces and/or movements therebetween. Preferably, the first transmission element 50 may be designed as a gear comprising teeth 51 along its outer circumference.

As indicated, the opening and/or closing mechanism 20 may comprise an energy storage 80. A release of energy stored in the energy storage 80 may provide for and/or support the retraction of the flexible tension member 21. In the embodiment of the drawings, the energy storage 80 comprises a spring 81. More specifically, the spring 81 may be a torsion spring, presently as preferred a helical torsion spring.

The spring 81 may, in a longitudinal first end region 82 be secured against a rotation about its longitudinal axis. In a longitudinal second end region 83 opposite the first end region 82, the spring 81 may be coupled to a second transmission element 60 of the transmission mechanism 75. Preferably, the second transmission element 60 may be designed as a gear comprising teeth 61 along its outer circumference. The second transmission element 60 may be rotatable about a second rotational axis A2. In particular, the second transmission element 60 may be rotatably held at the support body 30. Preferably, the second rotational axis A2 may be parallel to the first rotational axis A1.

The first transmission element 50 and the second transmission element 60 may be in operative engagement with one another. In particular, as in the present embodiment, the first transmission element 50 and the second transmission element 60 may be arranged such that their teeth 51, 61 are meshing with one another. This way, the transmission mechanism 75 may transform forces and/or movements between the retracting device 40 and the energy storage 80 during charging and/or releasing of energy from the energy storage 80.

More particularly, winding up of the flexible tension member 21 on the spool 41 during retraction and unwinding of the flexible tension member 21 from the spool 41 during extraction, i.e. rotation of the spool 41 about the first rotational axis A1, may be translated to a rotation of the second end region 83 of the spring about the second rotational axis A2. Rotation of the second end region 83 of the spring about the second rotational axis A2, the first end region 82 being secured against rotation, may thus increase or decrease the amount of energy stored in the spring 81 in the form of elastic deformation, respectively.

By choice of design specifics of the transmission mechanism 75, in particular by choosing a ratio of diameters of the transmission elements 50, 60, a transmission ratio between the force obtained from or supplied to the spring and the force transmitted by the flexible tension member 21 may be designed according to the desired force characteristics. A further degree of freedom for the design of the transmission ratio may lie within choosing the ratio of diameters of the first transmission element 50 and the spool 41.

The desired force characteristics may include the desired length along the main opening direction D1 along which the door attachment units 11, 11′ should be urged by the opening and/or closing mechanism 20. Preferably, this may correspond to the complete opening path of the door attachment unit 11, 11′ and/or the associated sliding door 5, 6. The desired force characteristics may also include the desired magnitude of force to be supplied to and/or between the door attachment units 11, 11′.

FIG. 6 provides a perspective exploded view of the opening and/or closing mechanism 20. Accordingly, the spool 41 may be rotatably held at the support body 30 by means of a bearing means 55. In the present embodiment, the bearing means 55 comprises a longitudinal shaft 56 and a head 57. The shaft 56 may or may not comprise a thread. The shaft 56 may be guided through a bearing bore 42 which may be provided centrally through the spool 41. At its end facing away from the head 57, the bearing means 55 may be fixed to the support body 30. For instance, the support body 30 may comprise a bearing receptacle 31, which may be a bore, in which the shaft 56 may be partially received. The bearing means 55 may, in particular with its shaft 56, be aligned with the first rotational axis A1.

As stated above, the first transmission element 50 may be rotatable about the same first rotational axis A1 as the spool 41, but rotationally fixed to the spool 41. As shown in FIG. 6, rotatability of the first transmission element 50 may be achieved in that the first transmission element 50 is held on the bearing means 55. For this purpose, the first transmission element 50 may comprise a central bore 52 partially receiving the bearing means 55, in particular partially receiving the shaft 56.

As further shown in FIG. 6, rotational fixing to the spool 41 may be achieved by provision of one or more locking means 58. Preferably, the locking means 58 may be designed as pins.

The first transmission element 50 and the spool 41 may comprise locking receptacles 53, 43 at least partially receiving the locking means 58.

The spool 41 and the first transmission element 50 may thus be rotatably held on the bearing means 55. To improve rotatability and/or to reduce wear, a washer 54 can be provided between the head 57 of the bearing means 55 and the first transmission element 50. Further, it is conceivable that a washer is provided between the spool 41 and the support body 30. The washer(s) may be made from a friction reducing material, for instance from a plastic or bronze material.

It is, in the alternative, also conceivable, that the spool 41 and the first transmission element 50 are rotationally fixed on the bearing means 55. In this case it may be provided that the bearing means 55 is rotatably held at the support body 30 to enable rotation about the first rotational axis A1.

FIG. 7 is a sectional view at the location indicated with VII in FIG. 5. From the exploded view of FIG. 6 and the sectional view of FIG. 7 it can be gathered that the second transmission element 60 may be rotatably held at the support body 30 by means of a fixing means 65. In particular, the second transmission element 60 may comprise a central bore 62 through which a shaft 67 of the fixing means 65 may be guided. Further, the support body 30 may comprise a bearing receptacle 32, which may be designed as a bore, through which the shaft 67 may be guided. Preferably, as in the shown embodiment, the shaft 67 may be provided with an external thread and the bearing receptacle 32 of the support body 30 may be provided with a matching internal thread. The shaft 67 may thus be guided through the bearing receptacle 32 from a side facing away from the second transmission element 60 until a head 66 of the fixing means 65 abuts the support body 30, such that the second transmission element 60 can be tightened against the support body 30.

To provide enhanced rotatability of the second transmission element 60 and/or to reduce wear, a washer 64, preferably made from a friction reducing material, may be provided between the support body 30 and the second transmission element 60.

Neighboring the second transmission element 60 opposite the support body 30, a rod 70 may be arranged, which may be arranged along the second rotational axis A2, and on which rod 70 the spring 81 may be held. The rod 70 may comprise a first end region 71 and a second end region 72, wherein the second end region 72 may face toward the second transmission element 60. The rod 70 may be secured against a rotation about the second rotational axis A 2. As in the embodiment shown, the rod 70 may, in its second end region 72, be fixed to the fixing means 65. For this purpose, the rod 70 may comprise a bore 74 arranged along its longitudinal axis and/or the second rotational axis A2, which bore 74 may comprise an internal thread. In this way, the rod 70 may be tightened against an external thread of the fixing means 65 in an end region of the fixing means 65 facing the rod 70.

To ensure rotatability of the second transmission element 60, provision may need to be made that the rod 70 does not, by tightening to the fixing means 65, clamp the second transmission element 60 against the support body 30 and/or the washer 64. For this purpose, a spacing 77 may be provided between the rod 70 and the second transmission element 60 along the second rotational axis A2. For instance, the fixing means 65 may, in the end region of the fixing means 65 facing the rod 70, comprise a smaller cross section compared to the area of the fixing means 65 on which the second transmission element 60 is held. In other words, a shoulder (not shown) may be provided on the fixing means 65 against which the rod 70 may abut in its second end region 72.

As mentioned before, the spring 81 may be held at the rod 70. In particular, an internal space of the helical torsion spring 81 may partially receive the rod 70 along the second rotational axis A2. In its first end region 82, the spring 81 may be fixed to the rod 70 at a fixing section 76 by any suitable means, such that a rotation of the first end region 82 about the second rotational axis A2 is blocked.

In its second end region 83 opposing the first end region 82, the spring may be coupled to the second transmission element 60. In particular, a coupling element 84, which may be a bent off portion of the spring 81, may be received in a correspondingly designed counter coupling element 63, in particular a bore, of the second transmission element 60. This way, the second end region 83 of the spring is rotatable together with the second transmission element 60 about the second rotational axis A2. A rotation of the second transmission element 60, and consequently of the second end region 83, may thus provide for a twisting of the spring 81, thereby providing for charging or releasing energy of the spring 81 in the form of increasing or decreasing elastic deformation of the spring 81.

Preferably, it may be provided that the tension of the spring 81 can be adjusted. In particular, in the case of a torsion spring, more particularly a helical torsion spring, the tension may be adjusted by a defined twisting of the second end region 83 against the first end region 82 of the spring 81 about the second rotational axis A2.

Such adjustability may be provided in that the rotational blocking of the rod 70 and/or the fixing section 76 may selectively be released in order to provide for a defined rotation about the second rotational axis A2. By such a defined rotation a defined twisting of the end regions 82, 83 of the spring 81 to one another may be achieved.

For example, the fixing section 76 of the rod 70 may be adapted to be rotationally adjustable relative to the remaining parts of the rod 70, in particular to the second end region 72 of the rod 70. It is conceivable that the fixing section 76 may be rotatably adjustable relative to the second end region 72 by means of a latching connection, in particular by a ratchet configuration, preferably comprising one or more ratchet disks. By such a connection, the angular relationship between the fixing section 76 and the second end region 72 may be adjustable in defined angular steps.

To provide for comfortable adjustment of the tension of the spring 81, the rod 70 may, in its first end region 71, comprise a head 73 configured to be engaged with a tool, such as a screw driver. Preferably, the head 73 may be selectively rotatable about the second rotational axis A2 together with the fixing section 76. For engaging with a tool, the head 73 may comprise a screw drive, preferably, as shown, a Phillips drive.

Summarizing the above, the retracting device 40 is adapted to retract the flexible tension member 21 under release of energy stored in the energy storage 80. By retraction of the flexible tension member 21, the door attachment unit 11 is urged in and/or against the main opening direction D1, by which the opening and/or closing of the sliding door 5 is facilitated for the user.

In the shown embodiment, the flexible tension member 21 transmits a force between both door attachment units 11, 11′. Further, the opening and/or closing mechanism 20 of the present embodiment is adapted for the flexible tension member 21 to provide an opening force, i.e. to urge the sliding door 5 in the main opening direction D1 toward its open state once it has been moved from the closed to the intermediate state. Further, in the present embodiment, also the further sliding door 6 may be urged toward its open state by the opening and/or closing mechanism 20. In this case, urging is effected against the main opening direction D1. That is, one opening and/or closing mechanism 20 may provide for comfortable opening of more than one sliding door 5, 6, such that this arrangement may be preferable if more than one sliding door 5, 6 is provided.

Other arrangements of the opening and/or closing mechanism 20 are of course conceivable. For instance, the attachment point 24 of the flexible tension member 21 may be provided in a stationary manner relative to the cabinet, and the retracting device 40 may be fixed to one of the door attachment units 11, 11′ or vice versa. In this case, only the sliding door 5, 6 the respective door attachment unit 11, 11′ is associated with may be urged towards its open state by the opening and/or closing mechanism 20. Such an arrangement may, for example, be suitable if only one sliding door 5 is provided.

Further, it is also conceivable that the opening and/or closing mechanism 20 is arranged such that a sliding door 5, 6 is urged towards its closed and/or intermediate state. This may be achieved for the sliding door 5, for example, by a modification of the embodiment shown in the Figures in a way that the attachment point 24 of the flexible tension member 21 is not provided on the further door attachment unit 11′, but stationary relative to the cabinet 1 in a position spaced from the door attachment unit 11 against the opening direction of the door, i.e. in the case of sliding door 5, against the main opening direction D1.

1-15. (canceled)

1: A sliding door gear, comprising:
at least one door mounting assembly configured to mount at least one sliding door to a stationary structure, such that the door mounting assembly is movable relative to the stationary structure between a closed position and an open position along a main opening direction; and
an opening and/or closing mechanism including a flexible tension member and a retractor configured to retract the flexible tension member such that upon retraction of the flexible tension member the door mounting assembly is urged in and/or against the main opening direction.

17: The sliding door gear of claim 16, wherein:
the flexible tension member includes a wire, a cable, a rope or a tape.

18: The sliding door gear of claim 17, wherein:
the retractor includes a spool rotatable about a first rotational axis; and
during retraction of the flexible tension member the flexible tension member is wound up on the spool.

19: The sliding door gear of claim 16, wherein:
the flexible tension member is attached to either the door mounting assembly or the stationary structure at an attachment point spaced apart from the retractor, and the retractor is configured to be fixed to the other of the door mounting assembly or the stationary structure.

20: The sliding door gear of claim 16, wherein:
the at least one door mounting assembly includes a first door mounting assembly configured to mount a first sliding door to a stationary structure and a second door mounting assembly configured to mount a second sliding door to the stationary structure; and
the flexible tension member is attached to one of the first or second door mounting assemblies at an attachment point spaced apart from the retractor, and the retractor is attached to the other of the first or second mounting assemblies.

21: The sliding door gear of claim 16, wherein:
the opening and/or closing mechanism further includes an energy storage configured such that a release of energy stored in the energy storage retracts the flexible tension member.

22: The sliding door gear of claim 21, wherein:
the energy storage includes a spring; and
the energy stored in the energy storage is at least partially stored as an elastic deformation of the spring.

23: The sliding door gear of claim 22, wherein:
the spring is a helical torsion spring.

24: The sliding door gear of claim 23, wherein:
a tension of the spring is adjustable by a defined twisting of a second end region of the spring relative to a first end region of the spring about a longitudinal central axis of the spring.

25: The sliding door gear of claim 22, wherein:
a tension of the spring is adjustable.

26: The sliding door gear of claim 21, wherein:
the opening and/or closing mechanism further includes a transmission coupling the retractor to the energy storage.

27: The sliding door gear of claim 26, wherein:
the transmission includes first and second rotatable transmission elements in operative meshing engagement with one another.

28: The sliding door gear of claim 27, wherein:
the retractor includes a spool rotatable about a first rotational axis; and
the first rotatable transmission element is coupled to the spool in a rotationally fixed manner such that the first rotatable transmission element is rotatable about the first rotational axis together with the spool.

29: The sliding door gear of claim 27, wherein:
the second rotatable transmission element is coupled to the energy storage such that the second rotatable transmission element is rotatable about a second rotational axis such that a rotation of the second rotatable transmission element increases or decreases an amount of energy stored in the energy storage.

30: The sliding door gear of claim 29, wherein:
the energy storage includes a spring;
the spring includes a longitudinal first end region secured against rotation about the second rotational axis; and
the spring includes a longitudinal second end region opposite the longitudinal first end region, the longitudinal second end region coupled to the second rotatable transmission element in a rotationally fixed manner.

31: The sliding door gear of claim 30, wherein:
the energy storage includes a rod including a fixing section, and the longitudinal first end region of the spring is rotationally fixed to the fixing section of the rod, wherein the fixing section of the rod is blocked against rotation about the second rotational axis during opening or closing of the opening and/or closing mechanism.

32: The sliding door gear of claim 31, wherein:
the blocking of the fixing section against rotation about the second rotational axis is releasable such that an angular orientation of the rod and/or the fixing section about the second rotational axis is adjustable to adjust a tension of the spring.

33: The sliding door gear of claim 16, wherein the opening and/or closing mechanism further includes:
an energy storage configured such that a release of energy stored in the energy storage retracts the flexible tension member;
a transmission coupling the retractor to the energy storage; and
a support body supporting the retractor, the transmission and the energy storage, the support body being coupled to the stationary structure or to the door mounting assembly.

34: The sliding door gear of claim 16, further comprising:
at least one linear guide element configured to guide the door mounting assembly along the main opening direction.

35: The sliding door gear of claim 34, wherein:
the main opening direction is parallel to a front face of the at least one sliding door.
